(19) United States
(12) Patent Application Publication
(10) Pub. No.: US 2002/0038743 A1
(43) Pub. Date: Apr. 4, 2002

(54) Pad for disk brake

(75) Inventor: Shigeki Yoshimoto, Itami-shi (JP)

Correspondence Address: GREENBLUM & BERNSTEIN, P.L.C., 1941 ROLAND CLARKE PLACE, RESTON, VA, 20191, US

(73) Assignee: SUMITOMO (SEI) BRAKE SYSTEMS, Inc., Mie (JP)

(21) Appl. No.: 09/891,237

(22) Filed: Jun. 27, 2001

(30) Foreign Application Priority Data
Aug. 10, 2000 (JP) 2000-243047

(51) Int. Cl. F16D 69/00; F16D 65/092

(52) U.S. Cl. 188/250 R; 188/250 B

(57) ABSTRACT

Rusting on a friction material bonding surface of a backing plate of a disk brake pad is prevented to suppress lowering of the adhesion strength resulting from rust on the friction material. Edges of hole or uneven portion provided on the backing plate are removed by providing chamfers of R 0.3 mm or over. Thereafter, a rust-preventive film of a thermosetting resin and subjected to hardening treatment is provided on the surface of the backing plate to eliminate film-cut defects at the edges due to surface tension. The friction material is bonded to the rust-preventive film.

### BACKGROUND OF THE INVENTION

This invention relates to a pad for a disk brake having its reliability and durability increased by suppressing lowering of the bond strength of a friction material.

A pad for a disk brake (hereinafter simply referred to as a pad) is formed by bonding a friction material to a backing plate. Joining of the friction material is usually done by bonding with an adhesive. But with simple bonding, peeling of the friction material is feared. Therefore a method is adopted in which holes for molding are formed in the surface of the backing plate and the friction material is engaged in the holes. But the holes induce infiltration of water. Thus in Japanese patent publication 6-323351 and utility model publication 56-120440, using closed holes or ribs is disclosed. As their structural features, compared with holes extending through the backing plate, they prevent infiltration of water and thus rust on the bonding interface.

Also, it is known to subject the friction material bonding surface to rust-preventive treatment to prevent lowering of the bond strength which results from corrosion of the backing plate. Especially preferable rust-preventive treatment is to form a rust-preventive film of a thermosetting resin subjected to hardening treatment. Such rust-preventive films are disclosed in Japanese patent publications 2642076 and 5-99254.

A rust-preventive film formed of a thermosetting resin has a high rust-preventive effect and can be formed easily and at low cost compared with a method in which an iron oxide (Fe₃O₄) layer is formed on the surface of the backing plate, or a method in which a gas soft nitriding is performed.

But even if such a rust-preventive film of a thermosetting resin is provided, rust can develop on the surface of the backing plate to which a friction material is bonded.

When a pad manufactured by the method of patent publication 2642076 or 5-99254 was subjected to a corrosion resistance test, rust was observed which spread on the bonding surface of friction material with specific locations as starting points. Spread of rust was especially remarkable for ones in which uneven portions were formed on the friction material bonding surface.

As uneven portions on the backing plate for engaging the friction material, recesses or protrusions by half shearing (with a punch), those formed by other method than half shearing, or through holes are used. Among them, for ones having through holes, rust spreading concentrically around the holes were observed. Also, for a backing plate having no through holes too, rust developed along recess or protrusion.

Pads used for the test were common in that uneven portions were formed on the backing plate. Rust spread starting from edge of the uneven portions.

The rust-preventive film prevents corrosion of the surface of the backing plate by preventing the iron surface from contact with water or air. But if there are defects in the film, it begins to corrode from there. Since rust produced is of a porous structure, it makes the film afloat, thereby allowing water and air to invade into between the film and the iron surface. This is repeated, so that corrosion progresses under the film.

Thus, the rust-preventive film should be free of defects. But defects are observed in conventional rust-preventive films for pads. In an electricity conduction test performed for a film obtained by applying a resin dissolved in a solvent with a spray, a brush, etc. and drying and hardening it, electricity passed at edge portions formed by the formation of uneven portions. This means the presence of film-cut defects at the edge portions.

Also, in a test in which the surface was checked for corrosion after spraying salt water on backing plates having a rust-preventive film, it was confirmed that there were defects at the edge portions.

Similar defects were also found in rust-preventive films obtained by carrying out hardening treatment after powder painting.

It is presumed that such film-cut defects are formed because when a resin dissolved in a solvent is applied, the resin film is cut due to the influence of surface tension at the edge portions, and drying and hardening are carried out in such a state. Also if powder painting is used, it is probably because powder is difficult to adhere to the edge portions.

A friction material has innumerable communicating pores, and has water-retaining properties, so that once it absorbs water, moisture is continuously supplied to the film-cut defects, so that the portion where the friction material is bonded, particularly the edge portions of uneven portions are liable to corrode. The results of a corrosion resistance test has proved this.

An object of this invention is to eliminate film-cut defects of a rust-preventive film provided on the backing plate to suppress lowering of the bond strength of the friction material.

### SUMMARY OF THE INVENTION

According to this invention, there is provided a pad for a disk brake comprising a backing plate, a friction material, the backing plate having at least one of hole and uneven portion formed on its surface to engage the friction material, at least part of the hole or uneven portion having their edges removed, and a rust-preventive film of a thermosetting resin provided on the the surface of the backing plate, the friction material being bonded to the backing plate through the rust-preventive film.

Such a pad has a rust-preventive film present provided over the entire area of the surface to which the friction material is bonded. The rust-preventive film has preferably an average thickness of 10 μm or over. The edges of the hole and/or uneven portion are preferably removed by chamfering to arcuate surfaces having a radius of curvature of 0.3 mm or over.

The chamfering is preferably done by press forming.

The uneven portion for engagement with the friction material may be a recess or a protrusion formed by half shearing, or a recess or a protrusion formed on the surface of the backing plate by other method than half shearing (such uneven portions are disclosed in Japanese patent publication 6-323351, utility model publications 56-120440 and 5-31300), or a combination of different kinds of uneven portions such as through holes and recesses formed by half shearing. Removal of edges need not necessarily be done for all the hole, recess and protrusion present on the bonding surface. Even if only part of them having an especially large influence on the adhesion strength are subjected to edge removal treatment, improvement in durability is obtained.

If the edges of hole and/or uneven portion are removed, breakage of resin film due to surface tension will not occur after a resin dissolved in a solvent has been applied, and film cutting due to difficulty in depositing of powder will not occur when powder painting is carried out. Thus the entire area of the friction material bonding surface including the hole and/or uneven portion are covered by a film having no defects. Thus, the rust-preventive performance improves, so that lowering of adhesion strength is suppressed.

The pads provided with the rust-preventive film having an average thickness of 10 μm or over reveals stable rust-preventive effects.

For ones in which edges of hole and/or uneven portion are removed by chamfering to arcuate surfaces having a radius of curvature of 0.3 mm or over, film cutting due to surface tension is reliably prevented.

If chamfering for edge removal is carried out by press forming, complication of manufacture or lowering of productivity will not occur.

Other features and objects of the present invention will become apparent from the following description made with reference to the accompanying drawings, in which:

### BRIEF DESCRIPTION OF THE DRAWINGS

FIG. 1A is a front view showing an embodiment of a pad of this invention;

FIG. 1B is a sectional view along line A-A of FIG. 1A;

FIG. 1C is an enlarged view showing a portion of FIG. 1B;

FIG. 2A is a front view of another embodiment;

FIG. 2B is a cross-sectional view of the same;

FIG. 2C is an enlarged view showing a portion of FIG. 2B;

FIG. 3A is a front view of still another embodiment;

FIG. 3B is a cross-sectional view of the same;

FIG. 3C is an enlarged view of a portion of FIG. 3B;

FIG. 4A is a front view of a further embodiment;

FIG. 4B is a cross-sectional view of the same;

FIG. 4C is an enlarged view of a portion of FIG. 4B;

FIG. 5 is a microscopic view of portion Y in FIG. 1B;

FIG. 6 is a partially sectional view of the backing plate with the edge of the recess left; and

FIG. 7 is a view showing how rust develops on the pad of FIG. 3 (with an edge of the recess).

### DETAILED DESCRIPTION OF THE PREFERRED EMBODIMENT

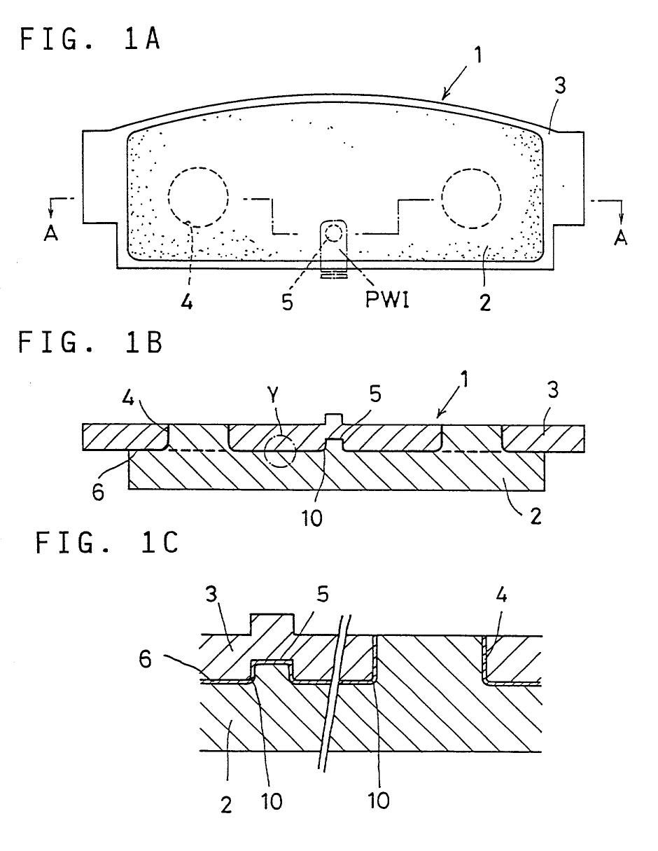

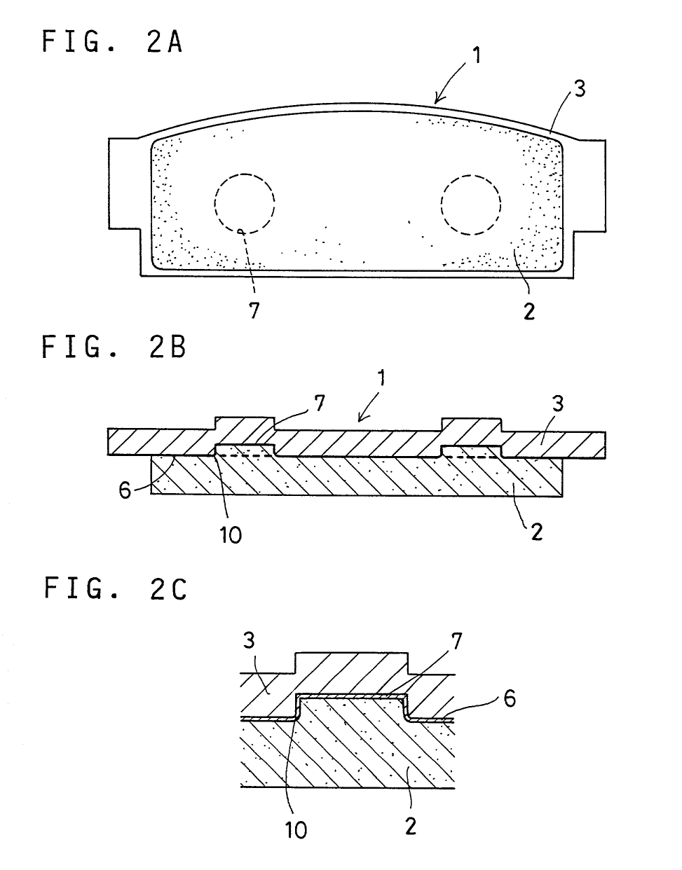

FIGS. 1-4 show various embodiments of this invention. The pad 1 of FIGS. 1A-1C is formed by providing its backing plate 3 with through holes 4 for receiving a friction material 2, and a small recess 5 formed by half shearing, providing a rust-preventive film 6 of a thermosetting resin on the surface of the backing plate 3 including the wall of the mold holes, and bonding the friction material 2 to the front side of the backing plate 3 through the film 6.

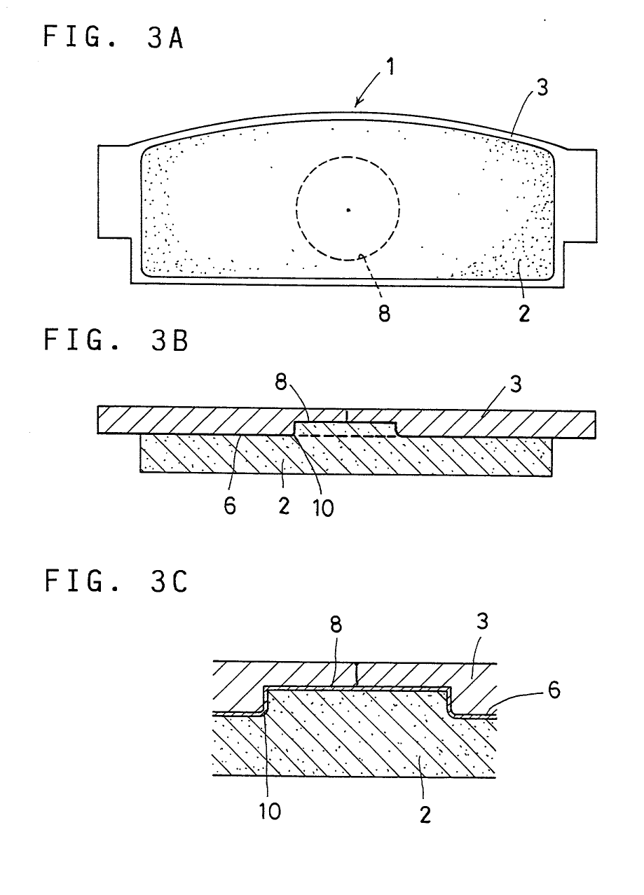

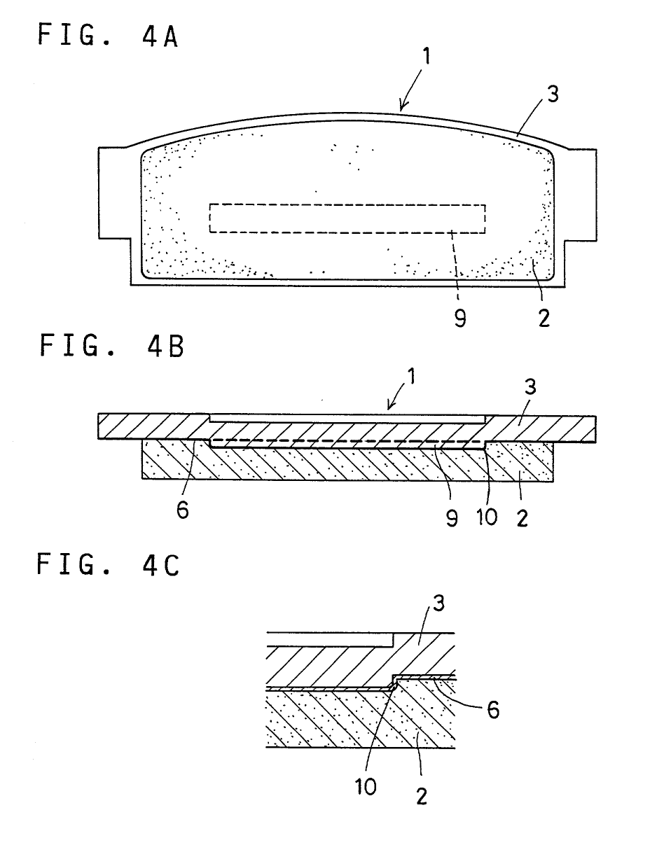

The pad 1 of FIGS. 2A-2C is formed with a plurality of large recesses 7 formed by half shearing in the bonding surface side of the backing plate 3 instead of the holes 4 and the small recess 5. The pad 1 of FIGS. 3A-3C is formed with a recess 8 in the bonding surface side of the backing plate 3 by a method disclosed in Japanese patent publication 6-323351. The pad 1 of FIGS. 4A-4C is formed with a rib 9 on the bonding surface side of the backing plate 3 by half shearing from the back side.

The small recess 5 of the pad of FIGS. 1A-1C is provided to form a protrusion for mounting a pad wear indicator PWI on the back side of the backing plate 3. The small recess 5, too, is filled with a friction material 2.

Any pad has its backing plate 3 formed of an iron-family material.

The edges of the openings of holes 4 on the front side of the backing plate, edges of the openings of the small recess 5 and recesses 7 and 8, and the peripheral edge of the rib 9 are removed by providing chamfers 10 having an arcuate surface. The rust-preventive film 6 is present at the chamfered corner portions, too.

As an adhesive for bonding the friction material 2, a phenolic resin or the like is used. This adhesive does not remain as a clear layer after formation into the pad. This is apparent from the fact that when a section of the pad provided with the rust-preventive film 6 was cut and enlarged by 1000 times by a microscope, the layer of rust-preventive film 6 was confirmed, while for the pad in which only the treatment with an adhesive was carried out without providing any rust-preventive film, the layer of adhesive could not be confirmed under a microscope. The reason therefor is considered because the adhesive does not remain as a layer by being absorbed into a mixed raw material for the friction material when the mixed raw material is hot press-molded on the backing plate 3. Thus it is considered that the adhesive has no rust-preventive function.

Hereinbelow, description is made with reference to Examples.

After the backing plates 3 having shapes shown in FIGS. 1A-4A and formed of hot rolled steel SAPH for automotive structure had been washed with trichloroethylene, the surface was roughened by shot-blasting. Thereafter, a phenolic resin solution was applied to the surface of the backing plate 3 by spraying. Next, each specimen was put in a furnace of 180° C. and subjected to heating treatment for one hour to evaporate the solvent to obtain a hardened rust-preventive film 6. Also, after it had been allowed to cool, a phenolic resin solution was applied on the rust-preventive film 6 by spraying, and it was dried in a furnace of 80° C. for 30 minutes to form a resin layer which still has an adhesion. With this as an adhesive, the friction material is bonded to the backing plate 3.

As the friction material 2, one comprising a mixed raw material containing 30 wt % steel fiber, 10 wt % glass fiber, 10 wt % alamide fiber, 20 wt % phenolic resin, 10 wt % barium sulfate, 10 wt % copper powder and 10 wt % friction dust was used.

The backing plate 3 having the rust-preventive film 6 and an adhesive layer was put in a heated mold, and the above mixed raw material was set and press-molded. The conditions were: mold temperature at 160° C., pressure at 10 MPa, and pressuring time of 10 minutes. The molded member thus obtained were further subjected to heating treatment at 200° C. for 10 hours to complete the pad.

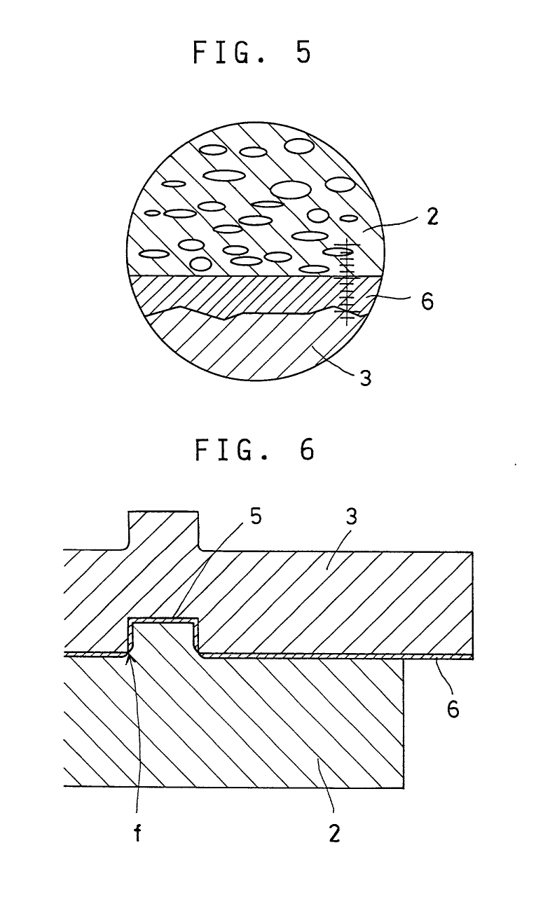

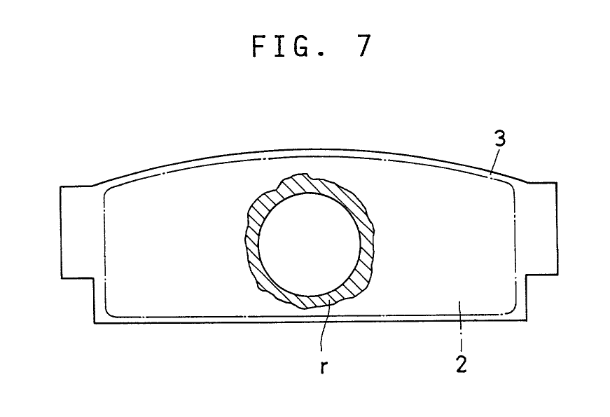

For the pad thus formed, the portion Y in FIG. 1B was enlarged by 1000 times by an optical microscope and observed. Its image is copied and shown in FIG. 5. By adding a scale to the microscopic image, it is possible to measure the thickness of the rust-preventive film 6. It is also possible to measure it with an electromagnetic film thickness meter before bonding the friction material. The film thickness measured by use of an electromagnetic film thickness meter and the film thickness measured by microscopically observing its section after completion of the pad show fairly close values.

Although a colored adhesive layer of the same phenolic resin was formed on the rust-preventive film 6, the existence of this layer was not found even in a 1000-fold enlarged image after completion of the pad. Thus, it can be considered that what influences the results of the following evaluation test is the rust-preventive film.

For evaluation, rust-preventive film 6 of a phenolic resin having average film thicknesses of 5 μm, 10 μm and 20 μm were formed on backing plates which have the edges of hole and/or uneven portion not removed and on backing plates in which they were removed by chamfering of R 1.0 (in mm). Then, the backing plates were examined for the presence of defects on the rust-preventive film thereon by conducting an electricity passing test.

f in FIG. 6 indicates a portion where a film-cut defect was confirmed for one having edges not removed. With the backing plates having edges of hole and/or uneven portion not removed, even for ones in which the average film thickness of the rust-preventive film 6 was thick, a film-cut defect was observed at the position shown. In contrast, with the backing plates having edges of hole and/or uneven portion removed by chamfering, although electric conduction was confirmed at a flat portion for ones in which the thickness of the rust-preventive film 6 was 5 μm, no abnormality was found for others.

Next, backing plates having edges of hole and/or uneven portion removed by chamfering of R 1.0 mm (ones having no rust-preventive films and ones provided with rust-preventive films having average film thicknesses of 5 μm, 10 μm and 20 μm) were prepared for a salt water-spraying test (in which 5% salt water at 35° C. was sprayed for 120 hours) to confirm portions where rust developed.

As a result, for the backing plates having no rust-preventive film and those having a rust-preventive film having an average film thickness of 5 μm, not only at corner portions of the hole and/or uneven portion, but at flat portions, rusted portions were found, while for ones having a rust-preventive film having an average film thickness of 10 μm or over, no rust developed at flat portions or corner portions of hole and/or uneven portion.

Also a corrosion resistance test was conducted in which pads manufactured using the same backing plates as ones used in the salt water spray test (in the same manufacturing method and under the same conditions as described above) were exposed to wind and rain with the backing plate facing up and the friction material down, the friction material was peeled off by striking the backing plate with a hammer after let to stand for twelve months, and the friction material contact surface was examined for rusting.

As a result, for the pads having no rust-preventive film and ones having a rust-preventive film having an average film thickness of 5 μm, rust was found on the bonding surface, while for the pads having a rust-preventive film having an average film thickness of 10 μm or over, no rust was found not only on the flat portions but on the corner portions of hole and/or uneven portion.

The test results are listed in Table 1.

Table 2 shows the results of tests in which the same test as above was conducted for the pads having the shapes of FIGS. 1A-4A and rust-preventive film of a phenolic resin having an average film thickness of 20 μm, some of them having edges of hole and/or uneven portion left and the rest having those removed by providing chamfers of R of 0.1 mm, 0.3 mm and 1.0 mm.

In the corrosion resistance tests for the pads having edges of hole and/or uneven portion left, in spite of the fact that they were of such a structure that infiltration of water was prevented by providing closed holes in the backing plate or by facing the backing plate up, no good results were obtained for any specimens.

Also, for ones in which the edge chamfers were as small as R 0.1 mm, electrical conduction was observed at chamfered corners. Also, in the salt water spraying test and the corrosion resistance test, slight rusts were observed at corner portions, though they were not so remarkable as for the pads having edges not removed.

In contrast, for ones in which chamfers of R 0.3 mm and R 1.0 mm were formed, good results were obtained in all the tests.

FIG. 7 shows a rusting state of the pads subjected to the corrosion resistance test (ones in which edge at the opening of the recess 8 was left in the embodiment of FIG. 3A). The portion r is where rust developed. Rust spread concentrically around the opening of the recess 8 with the edge as a starting point.

As a resin for the rust-preventive film and for bonding, a phenolic resin was used as an example here. But other thermosetting resin such as epoxy or melamine may be used.

Also, the chamfers for removing the edges of hole and/or uneven portion were formed by press-deforming the edges using a punch having a forming surface. Although it is not limited to this method, press-forming makes it possible to form stable arcuate surfaces more easily and inexpensively than chamfering by cutting.

As described above, since with the brake pad of this invention, film-cut defects of the rust-preventive film provided on the surface of the backing plate for engaging the friction material are eliminated by removing edges of hole and/or uneven portion on the backing plate, lowering of the bonding strength due to rusting on the friction material bonding surface is suppressed. Thus reliability and durability improve.

Ones having a rust-preventive film with an average film thickness of 10 μm or over, or ones having edges of the hole and/or uneven portion removed by chamfering of R 0.3 mm or over are especially large in the above effect.

Chamfering of the edges by press forming will not incur lowering of productivity and cost increase.

TABLE 1
Results of film defect test & corrosion resistance test

| | | test of rust preventive film | | corrosion |
|---|---|---|---|---|
| edge | | electrical | | resistance |
| cham- | average thickness of | conduction | salt water | test for |
| fering | rust preventive film | test *1 | spray *2 | the pads *3 |
| R 1.0 | 0 μm | X | X | X |
| | 5 μm | X | Δ | Δ |
| | 10 μm | ◯ | ◯ | ◯ |
| | 20 μm | ◯ | ◯ | ◯ |

*1 X: conduction observed at flat portion
◯: conduction not observed at flat portion or corners of holes or uneven portions
*2 X: rust remarkably observed at flat portion
Δ: rust slightly observed at flat portion
◯: rust not observed at flat portion or corners of holes or uneven portions
*3 X: rust remarkably observed at flat portion
Δ: rust slightly observed at flat portion
◯: rust not observed at flat portion or corners of holes or uneven portions

TABLE 2
Results of film defect test & corrosion resistance test

| | | | test of rust preventive film | | corrosion |
|---|---|---|---|---|---|
| | | | electrical | | resistance |
| Shape | edge | average thickness of | conduction | salt water | test for |
| of pad | chamfering | rust preventive film | test *4 | spray *5 | the pads *6 |
| | no chamfering | 20 μm | X | X | X |
| | R0. 1 | 20 μm | X | Δ | Δ |
| | R0. 3 | 20 μm | ◯ | ◯ | ◯ |
| | R1. 0 | 20 μm | ◯ | ◯ | ◯ |
| | no chamfering | 20 μm | X | X | X |
| | R0. 1 | 20 μm | X | Δ | Δ |
| | R0. 3 | 20 μm | ◯ | ◯ | ◯ |
| | R1. 0 | 20 μm | ◯ | ◯ | ◯ |
| | no chamfering | 20 μm | X | X | X |
| | R0. 1 | 20 μm | X | Δ | Δ |
| | R0. 3 | 20 μm | ◯ | ◯ | ◯ |
| | R1. 0 | 20 μm | ◯ | ◯ | ◯ |
| | no chamfering | 20 μm | X | X | X |
| | R0. 1 | 20 μm | X | Δ | Δ |
| | R0. 3 | 20 μm | ◯ | ◯ | ◯ |
| | R1. 0 | 20 μm | ◯ | ◯ | ◯ |

*4 X: conduction observed at corners of holes or uneven portions
◯: conduction not observed at any areas including corners of holes or uneven portions
*5 X: rust observed at corners of holes or uneven portions
Δ: rust slightly observed at corners of holes or uneven portions
◯: no rust observed at any areas including corners of holes or uneven portions
*6 X: rust observed at corners of holes or uneven portions
Δ: rust slightly observed at corners of holes or uneven portions
◯: no rust observed at any areas including corners of holes or uneven portions

What is claimed is:

1. A pad for a disk brake comprising a backing plate, a friction material, said backing plate having at least one of hole and uneven portion formed on its surface to engage said friction material, at least part of said hole or uneven portion having their edges removed, and a rust-preventive film of a thermosetting resin provided on the the surface of said backing plate, said friction material being bonded to said backing plate through said rust-preventive film.

2. The pad for a disk brake as claimed in claim 1 wherein said rust-preventive film is provided over the entire area of the surface to which the friction material is bonded, and has an average thickness of 10 μm or over.

3. The pad for a disk brake as claimed in claim 1 or 2 wherein the edges of said hole and/or uneven portion are removed by chamfering to arcuate surfaces having a radius of curvature of 0.3 mm or over.

4. The pad for a disk brake as claimed in claim 3 wherein said chamfering is done by press forming.

5. The pad for a disk brake as claimed in any of claims 1-4 wherein said uneven portion is a recess or a protrusion formed on the surface of said backing plate.
